(19) United States
(12) Patent Application Publication
(10) Pub. No.: US 2011/0117883 A1
(43) Pub. Date: May 19, 2011

(54) ENCRYPTED TEXT MESSAGING SYSTEM AND METHOD THEREFOR

(76) Inventor: DAVID DRABO, Gilbert, AZ (US)

(21) Appl. No.: 12/622,318

(22) Filed: Nov. 19, 2009

(51) Int. Cl. H04M 1/66; H04W 4/14; H04K 1/00

(52) U.S. Cl. 455/411; 455/466; 380/247

(57) ABSTRACT

A method for securing text messages ads an encryption-decryption module to a pair of cellular phones. A text message is entered on a first of the pair of cellular phones. The text message is encrypted on the first of the pair of cellular phones. The encrypted text message is transmitted to a second of the pair of cellular phones.

### FIELD OF THE INVENTION

This invention relates to text messaging and, more specifically, to a system and method to allow for secure transmission of text messages over a cellular network wherein the text message may only be decoded by a user having a designated key.

### BACKGROUND OF THE INVENTION

Text messaging is a term used to describe the exchange of brief written messages between cellular phones over a cellular network. While the term most often refers to messages sent using the Short Message Service (SMS), it has been extended to include messages containing image, video, and sound content, such as Multimedia Message Service (MMS) messages. Individual messages are referred to as “text messages” or “texts”.

Texting is extremely popular worldwide. In the United States alone, the average number of text messages sent per subscriber per month was 188. In the third quarter of 2006, at least 12 billion text messages crossed AT&T's network, up almost 15 percent from the preceding quarter. The design of full QWERTY keypads on cellular phones has further increased the ease and popularity of texting.

In general, cellular phones send signals to a cell phone tower over a pathway called a control channel so that the cell phone system knows which cell area the cellular phone is located in, and so that the cellular phone can change cell areas as a person moves around. The cellular phone uses the control channel for call setup. The control channel also provides a pathway for text messages. When a user sends a text message, the cellular phone of the user sends the text message to a cell tower on the control channel as data packets. The data packets go from the cell tower to a Short Message Service Center (SMSC) and from there to a receiving cellular phone via another cell tower.

Presently, text messages are unsecured. Thus, the data packets may be intercepted and read as the data packets travel over the control channel. Further, most SMSCs will store all text messages. These text messages are store at the SMSC for a predetermined length of time. Since the text messages are unsecured, the text messages may be viewed and read at the SMSC.

Therefore, a need existed to provide a system and method to overcome the above problem. The system and method would provide for secured transmission of text messages.

### SUMMARY OF THE INVENTION

A method for securing text messages comprising: adding an encryption-decryption module to a pair of cellular phones; entering a text message on a first of the pair of cellular phones; encrypting the text message on the first of the pair of cellular phones; and transmitting the encrypted text message to a second of the pair of cellular phones.

A method for securing text messages comprising: adding an encryption-decryption module to a pair of cellular phones; selecting a desired recipient of a text message on a first of the pair of cellular phones; entering the text message on the first of the pair of cellular phones; encrypting the text message on the first of the pair of cellular phones, the text message encrypted using a public key; and transmitting the encrypted text message to a second of the pair of cellular phones.

The present invention is best understood by reference to the following detailed description when read in conjunction with the accompanying drawings.

### BRIEF DESCRIPTION OF THE DRAWINGS

FIG. 1 is a simplified functional block diagram of a system of the present invention;

FIG. 2 is a diagram showing cellular phone zones;

FIG. 3 is a simplified functional block diagram of a cellular phone having encryption/decryption software; and

FIG. 3 is a simplified functional block diagram of a method of transmitting secured text messages.

Common reference numerals are used throughout the drawings and detailed description to indicate like elements.

### DETAILED DESCRIPTION

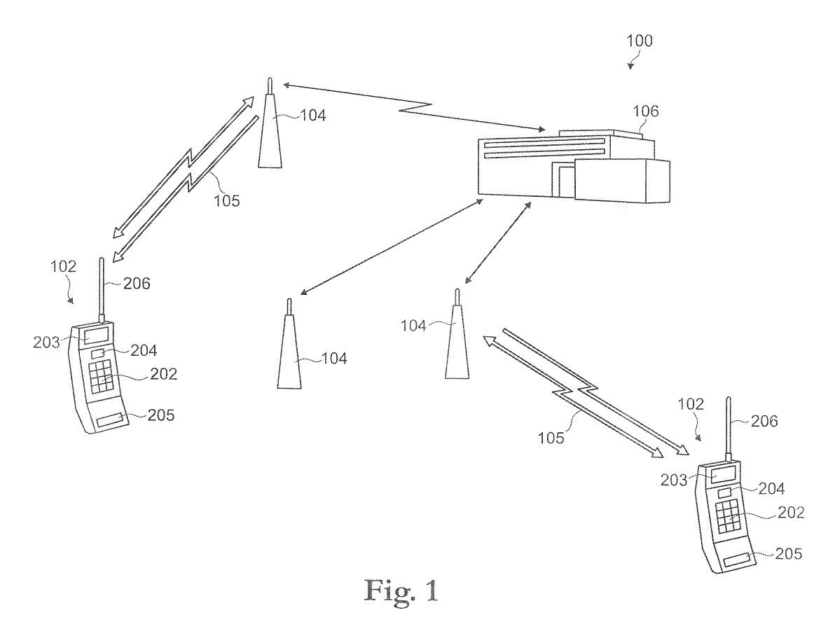

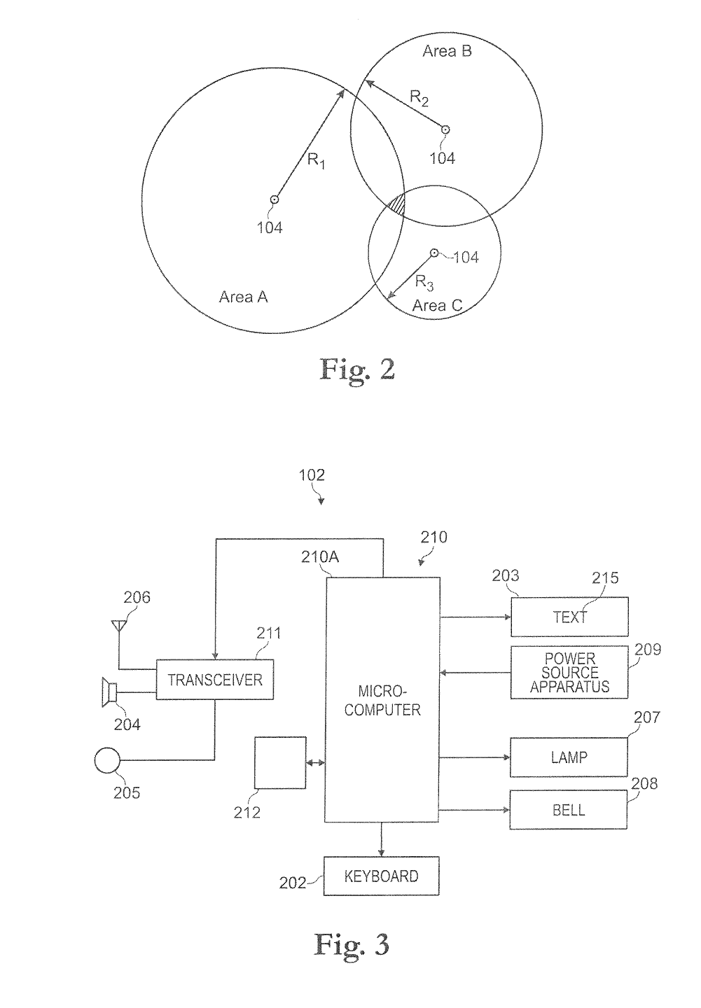

Referring to FIGS. 1 and 2, a cellular system 100 is shown. The cellular system 100 may have a plurality of cellular phones 102. While FIG. 1 shows two cellular phones 102, this is only shown as an example. Any number of cellular phones 102 may use the cellular system 100 without departing from the spirit and scope of the present invention. The cellular system 100 may have a plurality of cellular towers 104. The cellular phones 102 send signals to one or more cell phone towers 104. The signals are sent over a pathway called a control channel 105 so that the cellular system 100 knows which cell area (Area A, B, C) the cellular phones 102 are located. In general, all calls, text messages, and the like are routed through a cell carrier 106.

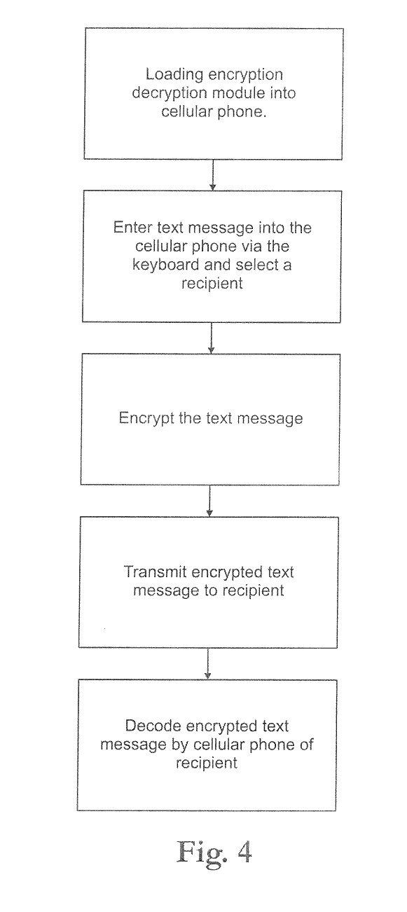

Referring to FIG. 3, a block diagram of a cellular phone 102 according to one embodiment of the present invention is shown. The cellular phone 102 may have a keypad 202 a display 203, a speaker 204, a microphone 205, antenna 206, a lamp 207, a ringer 208, a power source apparatus 209, a control apparatus 210, and a transceiver 211.

The control apparatus 210 may be a microcomputer 210A or the like. The microcomputer 210A serves to control the display 203, the lamp 207, the ringer 208, the microphone switch 205, and the transceiver 211. The microcomputer 210A serves to control a telecommunicating state according to various control signals received through the antenna 206.

Each cellular phone 102 that wishes to send and receive secure text messages 215 will have an encryption-decryption module 212 loaded onto the cellular phone 102. The encryption-decryption module 212 may be a software upload, a hardware component, or a combination thereof. For example, the software upload may be loaded on the cellular phone 102 at the time of purchase of the cellular phone 102, or at a later time. The encryption-decryption module 212 may be a hardware component such as an encryption card that may be coupled to a memory slot, I/O port or the like of the encryption-decryption module 212. Again, if the encryption-decryption module 212 is a hardware component, the hardware component may be on the cellular phone 102 at the time of purchase of the cellular phone 102, or added on at a later time. The encryption-decryption module 212 may be provided by the cellular phone carrier or by a third party. In accordance with one embodiment, the encryption-decryption module 212 is a software program. The software program may be provided by a third party. The software program may be downloaded from a website of the third party provider. An owner of a cellular phone 102 may visit the website and download the software for the encryption-decryption module 212. The user may have to review and agree to an End User Licensing Agreement (EULA) of the third party prior to downloading. The user may further have to agree to some type of payment in order to download the software. The payment may be a one time fee, a monthly fee, or the like. The payment may be paid via a credit card, PayPal, deducted from a banking account, or the like.

Referring now to FIGS. 1-4, a user of a cellular phone 102 who wants to send a secure text message generally should have a text message enabled cellular phone 102 and a text message account with a cell phone carrier 106. The cellular phone 102 further should have an encryption-decryption module 212 loaded into the sending and receiving cellular phones 102. As stated above, the encryption-decryption module 212 may be a software upload, a hardware component, or a combination thereof. When a user wishes to send a text message 215, the user enters the text message into the cellular phone 102 via the keyboard 202 and selects a recipient from an address book of the cellular phone 102. The entered text may be displayed on the display 203. When the user presses a transmit button 216 to send the text message 215, the text data will first be encrypted by the encryption-decryption module 212. The encryption method may be a Symmetric-key cryptography encryption method, a public-key (also known as asymmetric key) cryptography encryption method or the like. The listing of the above is given as an example and should not be seen as to limit the scope of the present invention.

The encrypted text data is then transmitted by the cellular phone 102 of the sender to a cell tower 104 on the control channel as encrypted data packets. The encrypted data packets go from the cell tower 104 to a Short Message Service Center (SMSC) generally the cell carrier 106. The encrypted data packets are then sent to the cellular phone 102 of a designated receiving party via another cell tower 104. The designated receiving party being the person designated by the sending party and selected from the address book of the cellular phone 102 of the sending party.

In order for the designated receiving party to decode the encrypted data packets to read the text message, the cellular phone 102 of the designated receiving party should also have a text message enabled cellular phone 102 and a text message account with a cell phone carrier 106. The cellular phone 102 further should have an encryption-decryption module 212 loaded into the sending and receiving cellular phones 102. As stated above, the encryption-decryption module 212 may be a software upload, a hardware component, or a combination thereof. The encryption-decryption module 212 should have a key for decrypting the encrypted data packets received.

In a symmetric key cryptography encryption method, a single secure key is shared by the sender and receiver of the text message for both encryption and decryption. To use a symmetric encryption scheme, the sender and receiver must securely share a key in advance. In this type of encryption method, when loading the encryption-decryption module 212, the owner of the cellular phone 102 would generally have to designate a list of recipients. The cellular phone 102 of the owner and each of the designated recipients would then have to be loaded with the encryption-decryption module 212 having the shared key.

In a public-key cryptography encryption method, asymmetric key algorithms are used, where the key used to encrypt the text message on the cellular phone 102 of the sender is not the same as the key used to decrypt the encoded text message on the cellular phone 102 of the recipient. Each user has a pair of cryptographic keys—a public key and a private key. The private key is kept secret, whilst the public key may be widely distributed. Messages are encrypted with the recipient's public key and can only be decrypted with the corresponding private key. The keys are related mathematically, but the private key cannot be feasibly (i.e., in actual or projected practice) derived from the public key.

Once the recipient has received the encrypted text message from the sender and decrypted the text message, the decrypted text message will be shown on the display 203 of the cellular phone 102 of the recipient. The recipient may then close the text message or send a reply. If the recipient closes the text message, the recipient may have an option to either save or delete the text message. If the recipient responds to the text message, the recipient will enter a response into the cellular phone 102 via the keyboard 202. The entered response may be displayed on the display 203. When the recipient presses a transmit button 216 to send the response, the response will first be encrypted by the encryption-decryption module 212. The encryption method may be a Symmetric-key cryptography encryption method, a public-key (also known as asymmetric key) cryptography encryption method or the like. The listing of the above is given as an example and should not be seen as to limit the scope of the present invention.

The encrypted response is then transmitted by the cellular phone 102 of the recipient to a cell tower 104 on the control channel as encrypted data packets. The encrypted data packets go from the cell tower 104 to a Short Message Service Center (SMSC) generally the cell carrier 106. The encrypted data packets are then sent to the cellular phone 102 of the original sender of the first text message via another cell tower 104 and decrypted by the encryption-decryption module 212 loaded into the cellular phones 102 of the sender of the original text message.

If the recipient closes and saves the original text message, the recipient may respond to the original text message at a later time. Once the recipient decides to respond, the recipient will open the original text message sent by the sender. The recipient will enter a response into the cellular phone 102 via the keyboard 202. The entered response may be displayed on the display 203. When the recipient presses a transmit button 216 to send the response, the response will first be encrypted by the encryption-decryption module 212. The encryption method may be a Symmetric-key cryptography encryption method, a public-key (also known as asymmetric key) cryptography encryption method or the like. The listing of the above is given as an example and should not be seen as to limit the scope of the present invention.

The encrypted response is then transmitted by the cellular phone 102 of the recipient to a cell tower 104 on the control channel as encrypted data packets. The encrypted data packets go from the cell tower 104 to a Short Message Service Center (SMSC) generally the cell carrier 106. The encrypted data packets are then sent to the cellular phone 102 of the original sender of the first text message via another cell tower 104 and decrypted by the encryption-decryption module 212 loaded into the cellular phones 102 of the sender of the original text message.

This disclosure provides exemplary embodiments of the present invention. The scope of the present invention is not limited by these exemplary embodiments. Numerous variations, whether explicitly provided for by the specification or implied by the specification, such as variations in structure, dimension, type of material and manufacturing process may be implemented by one of skill in the art in view of this disclosure.

What is claimed is:

1. A method for securing text messages comprising:
adding an encryption-decryption module to a pair of cellular phones;
entering a text message on a first of the pair of cellular phones;
encrypting the text message on the first of the pair of cellular phones; and
transmitting the encrypted text message to a second of the pair of cellular phones.

2. The method of claim 1 further comprising:
receiving the encrypted text message by the second of the pair of cellular phones; and
decrypting the encrypted text message by the second of the pair of cellular phones.

3. The method of claim 2 further comprising reading the text message after decrypting the encrypted text message.

4. The method of claim 3 further comprising one of saving the text message after decrypting the encrypted text message, deleting the text message after decrypting the encrypted text message, or responding to the text message after decrypting the encrypted text message.

5. The method of claim 4 further comprising:
entering a response text message on second of the pair of cellular phones;
encrypting the response text message on the second of the pair of cellular phones; and
transmitting the encrypted response text message to the first of the pair of cellular phones.

6. The method of claim 5 further comprising:
receiving the encrypted response text message by the first of the pair of cellular phones; and
decrypting the encrypted response text message by the first of the pair of cellular phones.

7. The method of claim 1 wherein adding an encryption-decryption module to a pair of cellular phones further comprises adding an encryption-decryption module to a pair of cellular phones wherein the encryption-decryption module uses a public-key cryptography encryption algorithm.

8. The method of claim 1 wherein adding an encryption-decryption module to a pair of cellular phones further comprises downloading a software encryption-decryption algorithm to the pair of cellular phones.

9. The method of claim 1 wherein adding an encryption-decryption module to a pair of cellular phones further comprises adding a hardware encryption-decryption module to the pair of cellular phones.

10. A method for securing text messages comprising:
adding an encryption-decryption module to a pair of cellular phones;
selecting a desired recipient of a text message on a first of the pair of cellular phones;
entering the text message on the first of the pair of cellular phones;
encrypting the text message on the first of the pair of cellular phones, the text message encrypted using a public key; and
transmitting the encrypted text message to a second of the pair of cellular phones.

11. The method of claim 10 further comprising:
receiving the encrypted text message by the second of the pair of cellular phones; and
decrypting the encrypted text message by the second of the pair of cellular phones using a private key.

12. The method of claim 11 further comprising reading the text message after decrypting the encrypted text message.

13. The method of claim 12 further comprising one of saving the text message after decrypting the encrypted text message, deleting the text message after decrypting the encrypted text message, or responding to the text message after decrypting the encrypted text message.

14. The method of claim 4 further comprising:
entering a response text message on second of the pair of cellular phones;
encrypting the response text message on the second of the pair of cellular phones using a public key on the second of the pair of cellular phones;
transmitting the encrypted response text message to the first of the pair of cellular phones;
receiving the encrypted response text message by the first of the pair of cellular phones; and
decrypting the encrypted response text message by the first of the pair of cellular phones using a private key on the first of the pair of cellular phones.

15. The method of claim 10 wherein adding an encryption-decryption module to a pair of cellular phones further comprises downloading a software encryption-decryption algorithm to the pair of cellular phones.

16. The method of claim 10 wherein adding an encryption-decryption module to a pair of cellular phones further comprises adding a hardware encryption-decryption module to the pair of cellular phones.

18. A method for securing text messages comprising:
downloading a software encryption-decryption module to a pair of cellular phones;
selecting a desired recipient of a text message on a first of the pair of cellular phones;
entering the text message on the first of the pair of cellular phones;
encrypting the text message on the first of the pair of cellular phones, the text message encrypted using a public key;
transmitting the encrypted text message to a second of the pair of cellular phones;
receiving the encrypted text message by the second of the pair of cellular phones; and
decrypting the encrypted text message by the second of the pair of cellular phones using a private key.

19. The method of claim 18 further comprising:
entering a response text message on second of the pair of cellular phones;
encrypting the response text message on the second of the pair of cellular phones using a public key on the second of the pair of cellular phones;
transmitting the encrypted response text message to the first of the pair of cellular phones;
receiving the encrypted response text message by the first of the pair of cellular phones; and
decrypting the encrypted response text message by the first of the pair of cellular phones using a private key on the first of the pair of cellular phones.

20. The method of claim 18 wherein downloading a software encryption-decryption module to a pair of cellular phones further comprises:
agreeing to an end user licensing agreement prior to downloading the software encryption-decryption module; and
entering payment for downloading the software encryption-decryption module.
